(19) United States
(12) Patent Application Publication
(10) Pub. No.: US 2023/0294934 A1
(43) Pub. Date: Sep. 21, 2023

(54) PNEUMATIC CONVEYANCE SYSTEM AND METHOD

(71) Applicant: Walinga Inc., Guelph (CA)

(72) Inventor: Ryan VanVeen, Guelph (CA)

(21) Appl. No.: 18/122,880

(22) Filed: Mar. 17, 2023

Related U.S. Application Data
(60) Provisional application No. 63/321,049, filed on Mar. 17, 2022.

(51) Int. Cl. B65G 53/66; B65G 53/06; G01P 5/02

(52) U.S. Cl. CPC B65G 53/66; B65G 53/06; G01P 5/02

(57) ABSTRACT

A pneumatic conveyance system for conveying a product between a first unit and a second unit, said system comprising: a conveying line configured for the product to be conveyed therethrough, the conveying line comprising a line inlet configured for coupling to the first unit for receiving the product from the first unit and a line outlet configured for coupling to the second unit for delivering the product to the second unit, a blower unit configured for blowing a flow of air through the conveying line for conveying the product, a sensor unit configured for measuring speed of air entering into the blower unit, and generating a sensor signal indicative thereof, and a controller configured to receive the sensor signal and to generate a control signal for controlling the blower unit based at least upon the measured speed.

### TECHNICAL FIELD

The presently disclosed subject matter relates generally to the field of pneumatic conveyance systems and methods.

### BACKGROUND

Many prior art pneumatic conveyance systems which incorporate a blower motor use air pressure or motor load to control blower speed. In order to ensure that the product to be conveyed (e.g. dry, loose granular materials, such as grains, food pellets and powders and other loose commodities) remains suspended in the air while conveying, a suitable air speed must be maintained. For example, a pneumatic conveyance system of the prior art could get plugged or partially plugged with the product to be conveyed, which in turn results in elevated air pressure within the conveyance system, but nil airspeed (i.e. 0 ft/min). Conversely, when a pneumatic conveyance system runs too fast (for example, in the case where the volume of the product within the system is too low), line pressure within the system increases. Using a Variable Frequency Drive (VFD) enables a user to slow down or speed up the blower motor so that product moves at the correct speed in relation to conveying distance and product volume and size, among other factors. A challenge with VFD systems is that the user needs to understand what speed is required for each distance or product (e.g. grain) and in turn, the user needs to constantly make adjustments (e.g. if the product is moving too slow in the conveying lines, it can cause the motor to overload and plug the conveying lines with the product).

In the example scenarios described above, while the objective of an efficient pneumatic conveyance system is to achieve optimal air speed within the system, line pressure is typically not an accurate indicator of optimal air speed, and altering line pressure provides no guarantee that optimal air speed will be reached.

In view of the foregoing, effecting changes to the blower speed within prior art pneumatic conveyance systems often results in inaccurate output speeds and difficulty matching conveying speed to a suitable set point. A novel and inventive solution to the prior art limitations is desired.

### SUMMARY OF PARTICULAR EMBODIMENTS

It will be appreciated by those skilled in the art that other variations of the embodiments described below may also be practiced without departing from the scope of the presently disclosed subject matter. Further note, these embodiments, and other embodiments of the present invention will become more fully apparent from a review of the description and claims which follow.

It is an object of the presently disclosed subject matter to define a pneumatic conveyance system and method wherein the system measures how fast air is moving the product through the conveying lines and makes adjustments to the blower speed. Such a system ensures that the product is always moving at the right speed without risk of plugging up the conveying lines with the product, and without the need for operator intervention.

Accordingly, there is provided according to a first aspect of the presently disclosed subject matter, a pneumatic conveyance system for conveying a product between a first unit and a second unit, said system comprising: a conveying line configured for the product to be conveyed therethrough, the conveying line comprising a line inlet configured for coupling to the first unit for receiving the product from the first unit and a line outlet configured for coupling to the second unit for delivering the product to the second unit; a blower unit configured for blowing a flow of air through the conveying line for conveying the product; a sensor unit configured for measuring speed of air entering into the blower unit, and generating a sensor signal indicative thereof; and a controller configured to receive the sensor signal and to generate a control signal for controlling the blower unit based at least upon the measured speed.

In some examples, the sensor unit can comprise a fixed member deployed to interact with the air entering into the blower unit and experience a force exerted thereupon by the air, and a force sensor operatively coupled to the fixed member and configured for measuring the force experienced by the fixed member and generating a voltage signal indicative of the force measurement, said voltage signal being configured to be converted into the measurement of the speed of the air entering into the blower unit.

In some examples, the controller can be configured to convert the voltage signal into analog value and then to a programmable logic controller (PLC) constituting the control signal.

In some examples, the fixed member is a plate configured to be stationary with respect to the air.

In some examples, the sensor unit comprises a velocity sensor configured for determining the speed of the air entering into the blower unit.

In some examples, the sensor unit can be configured to be positioned upstream of the blower unit. In other examples, the sensor unit can be deployed at any location for monitoring speed of the flow of air anywhere within the conveying line in a direction extending from the line inlet to the line outlet to measure how fast air is moving the product through the conveying line.

In some examples, the blower unit comprises a blower configured for blowing the flow of air, and a blower motor operatively connected to the blower and configured for driving the blower for blowing said flow of air. The blower motor can have a variable frequency drive (VFD) configured to adjust a speed of the blower, and the controller can be configured to control the VFD via the control signal. The blower can be a positive displacement blower. Or any other air moving device.

In some examples, the controller can be configured to receive a predetermined target value range, and to maintain a speed of the flow of air within the predetermined target value range. In some examples, the predetermined target value range can be a single target value, and the controller can be configured to maintain the speed of the flow of air at the target value.

In some examples, the controller can be configured to measure a quantity of the product being conveyed, and to adjust the predetermined target value range based at least thereupon.

In some examples, the pneumatic conveyance system can further comprise a communication interface configured for facilitating a user to enter commands to control the system, wherein the commands include system calibration commands.

There is provided according to a second aspect of the presently disclosed subject matter, a method for conveying a product between a first unit and a second unit, said method, performed by a pneumatic conveyance system, comprising: conveying the product through a conveying line, the conveying line comprising a line inlet coupled to the first unit for receiving the product from the first unit and a line outlet coupled to the second unit for delivering the product to the second unit; blowing, by a blower unit, a flow of air through the conveying line for conveying the product; measuring speed of air entering into the blower unit; generating a sensor signal indicative of the speed of air entering into the blower unit; generating a control signal for controlling the blower unit based at least upon the measured speed; and controlling the blower unit via the control signal.

In some examples, controlling the blower unit comprises controlling a variable frequency drive (VFD) of the blower unit for adjusting the speed of blower of the blower unit.

In some examples, the method further comprises receiving a predetermined target value range, and maintaining the speed of the flow of air within the predetermined target value range.

In some examples, the method further comprises measuring a quantity of the product being conveyed, and adjusting the predetermined target value range based at least thereupon.

There is provided according to a third aspect of the presently disclosed subject matter, a sensor unit configured for measuring speed of a flow of air, said sensor unit comprising: a fixed member configured to be deployed to interact with the flow of air and experience a force exerted thereupon by the flow of air; and a force sensor operatively coupled to the fixed member and configured for measuring the force experienced by the fixed member and generating a voltage signal indicative of the force measurement, said voltage signal being convertible into the speed of the flow of air.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example.

The drawings, together with the remainder of the specification, serve to explain principles and operations of the described and claimed aspects and examples. In the figures, each identical or nearly identical component that is illustrated in various figures is represented by a like numeral.

The figures enclosed herewith include schematic diagrams illustrating example pneumatic conveyance systems, and associated apparatuses and methods in accordance with different embodiments of the present disclosure. For purposes of clarity, not every component may be labeled in every figure. In the drawings:

FIG. 1A schematically illustrates a sensor system according to an embodiment of the presently disclosed subject matter;

FIG. 1B schematically illustrates a sensor system of FIG. 1 in operation;

FIG. 2 schematically illustrates a pneumatic conveyance system according to an embodiment of the presently disclosed subject matter;

FIG. 3 illustrates a flowchart depicting pneumatic conveyance system commissioning according to an embodiment of the presently disclosed subject matter;

FIG. 4 illustrates a flowchart depicting pneumatic conveyance system operation according to an embodiment of the presently disclosed subject matter;

FIG. 5 illustrates a flowchart depicting PID control according to an embodiment of the presently disclosed subject matter;

FIG. 6 illustrates a flowchart depicting operations of a monitoring system according to an embodiment of the presently disclosed subject matter;

### DETAILED DESCRIPTION OF PARTICULAR EMBODIMENTS

In this respect, before explaining at least one embodiment of the presently disclosed subject matter in detail, it is to be understood that the presently disclosed subject matter is not limited in its application to the details of construction and to the arrangements of the components set forth in the following description or illustrated in the drawings. The subject matter is capable of other embodiments and of being practiced and carried out in various ways. Also, it is to be understood that the phraseology and terminology employed herein are for the purpose of description and should not be regarded as limiting.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the presently disclosed subject matter. The appearances of the phrase “in one embodiment” or “in one variation” in various places in the specification are not necessarily all referring to the same embodiment or variation.

The term “couple”, “coupled”, “connected”, “joined”, “attached” or “fixed” as used in this specification and the appended claims refers to either an indirect or direct connection between the identified elements, components or objects. Often the manner of the coupling will be related specifically to the manner in which the two coupled elements interact.

The term “or” as used in this specification and appended claims is not meant to be exclusive rather the term is inclusive meaning “either or both”.

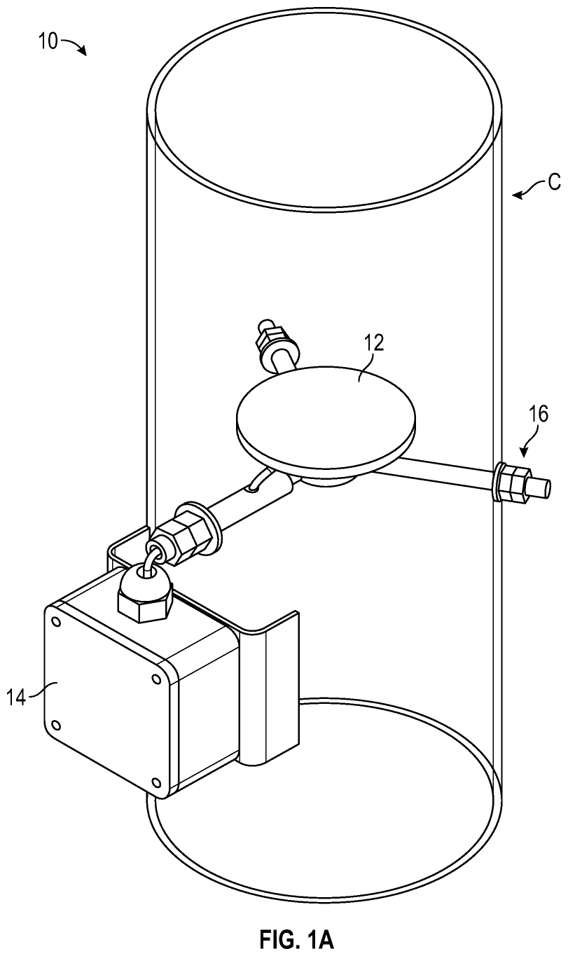

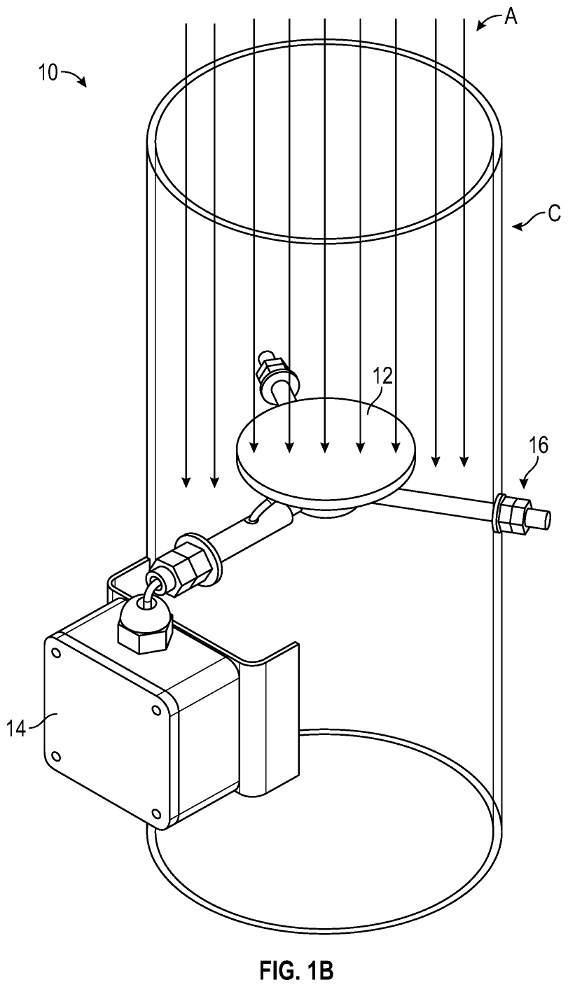

Reference is now made to FIGS. 1A and 1B schematically illustrating a sensor system (interchangeably used herein with sensor unit) 10 comprising a fixed member 12 and a force sensor 14 operatively coupled to each other. It is to be understood herein that for the purposes of this description, the term “operatively coupled” with respect to two components is intended to mean that the components are coupled to each other for performing their respective operations together and based on each other. The sensor system 10 is configured for measuring speed (and velocity) of a flow of air flowing in a conduit that can be an inlet tube, a conveying line, outlet tube, etc. of any system. In the illustrated embodiment the conduit C has been shown to be transparent for the purposes of illustration.

The fixed member 12, which in the illustrated embodiment is fixed plate 12 is deployed within the conduit C for interacting with the flow of air A and experience a force exerted thereupon by the air. The fixed plate 12 is fixedly deployed in the conduit C by the fixing arrangement 16, which in the illustrated embodiment includes rods and bolts. In some examples, the fixing arrangement can include other apparatus for fixedly deploying the plate 12 within the conduit while preventing the movement of the plate 12 with respect to the conduit C. The fixed plate 12 is operatively coupled to the force sensor 14 such that the force sensor 14 can measure the force experienced by the fixed plate 12 by the flow of air A. In the illustrated embodiment, the force sensor 14 is a load cell 14, however, in some examples, the force sensor can be any other sensor configured for measuring force exerted on the fixed plate 12. Also, in some examples, the size and/or shape of the fixed plate can be different as compared to the one illustrated herein.

The force sensor 14 outputs a voltage signal (i.e. change in voltage) and transmits the voltage signal to an amplifier which converts the voltage change to a 4-20 mA signal, and outputs the change in voltage to such analog signal. The voltage signal is indicative of the force exerted on the fixed plate 12 and can be converted, by a controller (such as the controller of a pneumatic conveyance system as described herein further below), into the speed of the flow of air A. The fixed plate is stationary and the sensor system 10 has no moving parts, and is not sensitive to dust issues.

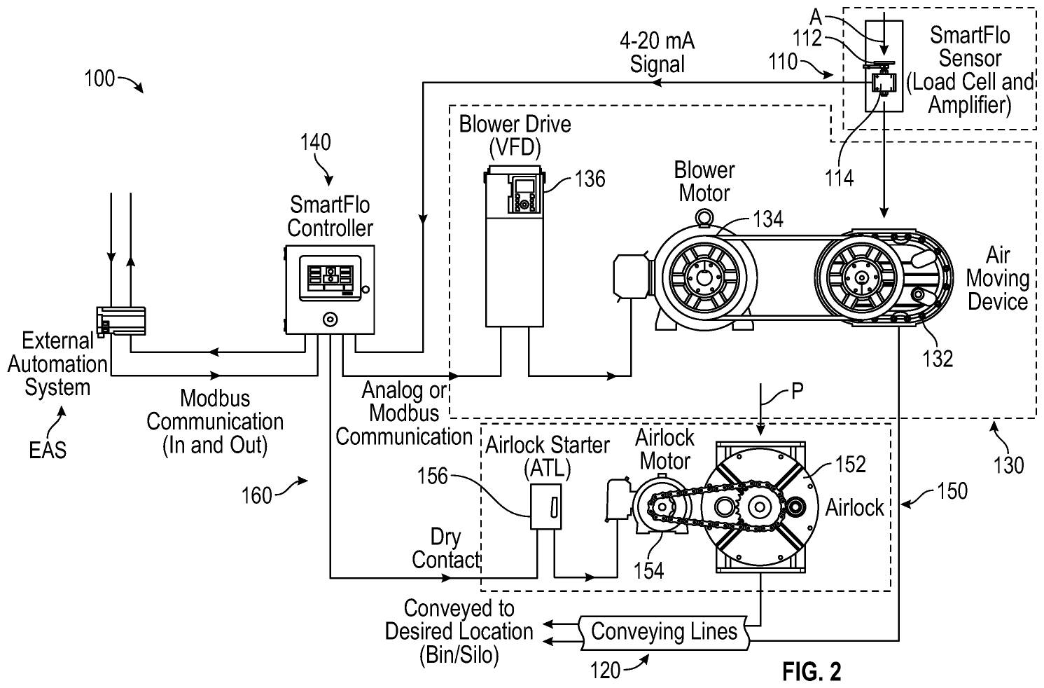

Reference is now made to FIG. 2 schematically illustrating a pneumatic conveyance system 100 according to an embodiment of the presently disclosed subject matter. The pneumatic conveyance system 100 can be utilised for conveying a product P (e.g. dry, loose granular materials, such as grains, food pellets and powders and other loose commodities) between different units such as storage units (bins/silos), transport units, processing units, etc. The pneumatic conveyance system 100 is configured for conveying the product between a first unit, being any one of the above-mentioned units (or any other unit), and a second unit, being any one of the above-mentioned units (or any other unit). In the illustrated embodiment, the pneumatic conveyance system uses velocity measurements, as opposed to air pressure, to determine suitable operation conditions.

Accordingly, the pneumatic conveyance system 100 comprises a sensor system (interchangeably used herein with sensor unit) 110 configured for measuring the speed (or velocity) of the air. It is to be understood herein that the sensor unit 110 can be same as the sensor unit 10 described above with respect to FIGS. 1A and 1B or can be any other velocity sensor or velocity measurement device. In the illustrated embodiment, the sensor unit 110 is same as the sensor unit 10 described above and corresponding reference numerals are used to denote corresponding components of the sensor unit 110. For instance, the sensor unit 110 includes a fixed plate 112 and a load cell 114 corresponding to the fixed plate 12 and force sensor 14, respectively, of the sensor unit 10. The sensor unit 110 includes all the features of the sensor unit 10 and the description of operation of sensor unit 10 applies analogously to the sensor unit 110.

The pneumatic conveyance system 100 has a conveying line 120 configured for the product to be conveyed therethrough. The conveying line 120 has a line inlet (not labelled in the schematic view for the purposes of clarity) configured for coupling to the first unit for receiving the product from the first unit and a line outlet (not labelled in the schematic view for the purposes of clarity) configured for coupling to the second unit for delivering the product to the second unit.

A blower unit 130 of the pneumatic conveyance system 100 is configured to blow a flow of air A through the conveying line 120 for conveying the product. In the illustrated embodiment, the sensor unit 110 is deployed upstream of the blower unit and is configured for measuring speed of air entering into the blower unit 130. In some examples, the sensor unit can be deployed at any location for monitoring speed of the flow of air anywhere within the conveying line in a direction extending from the line inlet to the line outlet to measure how fast air is moving the product through the conveying line. The sensor unit 110 generates a sensor signal indicative of the measured speed of air. In the illustrated embodiment, the sensor unit 110 generates a voltage signal, constituting the sensor signal, as described above in detail with respect to sensor unit 10.

The pneumatic conveyance system 100 further comprises a controller 140 configured to receive the sensor signal from the sensor unit and generate a control signal based on the sensor signal for controlling the blower unit based at least upon the measured speed. In the illustrated embodiment, the sensor signal is the voltage signal, and the controller is configured to convert the voltage signal into into analog value through use of a suitable amplifier, and then to a programmable logic controller (PLC) constituting the control signal for controlling the blower unit 130. It is to be understood herein that the controller may include a computer controller configured to perform operations in accordance with a set of instructions stored on a memory readable by the controller, which may be executed by a central processing unit (CPU), one or more processors, processor units, microprocessors, etc. In some examples, the controller may include one or more control circuits.

In one embodiment, the system measures air pressure in a direction perpendicular to the air flow, using the force sensor. The controller receives velocity data from the force sensor and utilises the velocity data in order to determine a course of action for conveying the product.

The blower unit 130 comprises a blower 132 configured for blowing the flow of air and a blower motor 134 operatively connected to the blower 132 and configured for driving the blower 132. In the illustrated embodiment, the blower 132 is a positive displacement blower, and the sensor unit 110 is installed upstream an air inlet of the positive displacement blower. In some examples, the blower can be any other air moving device. The blower motor 134 has a variable frequency drive (VFD) 136 for driving the blower motor 134 (for example, by varying the frequency and voltage supplied to the blower motor 134). The controller 140 is configured to control the VFD 136 via the control signal to adjust the speed of the blower motor 134, which in turn results in an adjustment to the speed at which the positive displacement blower operates.

The controller 140 is configured to receive a predetermined target value range for the desired speed of air, and to maintain the speed of the flow of air within the predetermined target value range. The target value range is pre-determined by comparison to industry standards of acceptable air speeds for dilute phase conveying. A user can provide the predetermined target value range into the system 100 via various channels/communication interfaces provided by the system 100 for the user to enter commands to control the system, as described in detail later herein below. In some examples, the predetermined target value range is a single target value, and the controller is configured to maintain the speed of the flow of air at the target value.

For instance, in an example, a user (or operator) selects a baseline air speed target value (range or a single value between 0-100%). Next, the user starts the operation of the pneumatic conveyance system 100. In turn, the controller 140 sends a forward run command to the blower variable-frequency drive (VFD). Using a proportional-integral-derivative (PID) loop, the controller 140 compares the current airspeed to the target value, and based on this comparison, the controller 140 sends a new speed to the VFD (faster or slower) in order to reach the desired target value. The controller 140 continually checks the airspeed and compares it to the target value and makes adjustments to the blower speed in order to have these two values match (using a PID loop).

The controller 140, in some examples, can be configured to detect how much product is being conveyed and adjusts the target value as well as the blower speed. For instance, in case more product is being conveyed, the system needs to target a higher target value. The change in the target value can be performed in steps, and size of each step can be provided by the user via various channels/communication interfaces provided by the system 100 for the user to enter commands to control the system, as described in detail later herein below.

In addition to the components and their operations described above, the pneumatic conveyance system 100 further includes an airlock unit 150 having an airlock 152 driven by an airlock motor 154, which is triggered by an airlock starter 156. The controller 140 controls the airlock unit 150 to operate the airlock 152 in order to facilitate the product entering into the conveying line 120 while preventing the air to escape therefrom.

The controller 140 communicates with the sensor unit 110, the blower unit 130, and the airlock unit 150 via communication lines 160, which can be wired or wireless communication enablers for transmitting sensor signals and control signals. In some examples, the communication lines 160 can be modbus communication. The pneumatic conveyance system 100 is further associated with an external automation system EAS configured to receive information related to operation of the pneumatic conveyance system 100 and provide (manually by the user or automatically) calibration and command instructions for operation of the pneumatic conveyance system 100.

The presently disclosed subject matter also provides a method performed by the pneumatic conveyance system 100, including conveying the product through the conveying line 120, blowing the flow of air A through the conveying line 120, measuring speed of air entering into the blower unit 130, generating the sensor signal indicative of the speed of air entering into the blower unit, 130, generating the control signal for controlling the blower unit 130, and controlling the blower unit via the control signal. The method further includes receiving a predetermined target value range, as described herein above, and maintaining the speed of the flow of air within the predetermined target value range. The method further includes measuring a quantity of the product being conveyed, and adjusting the predetermined target value range based thereupon.

The pneumatic conveyance system 100 provides several channels/communication interfaces for the user to enter instructions/commands for system commissioning and operation. The system provides a human-machine interface (HMI), using which a user can incorporate advanced systems settings into the system. For example, calibration functions (including calibration of the sensor and PID loop) can be added to help resolve issues that may occur because of differences from one system to another, including differences based on ambient temperatures and pressures.

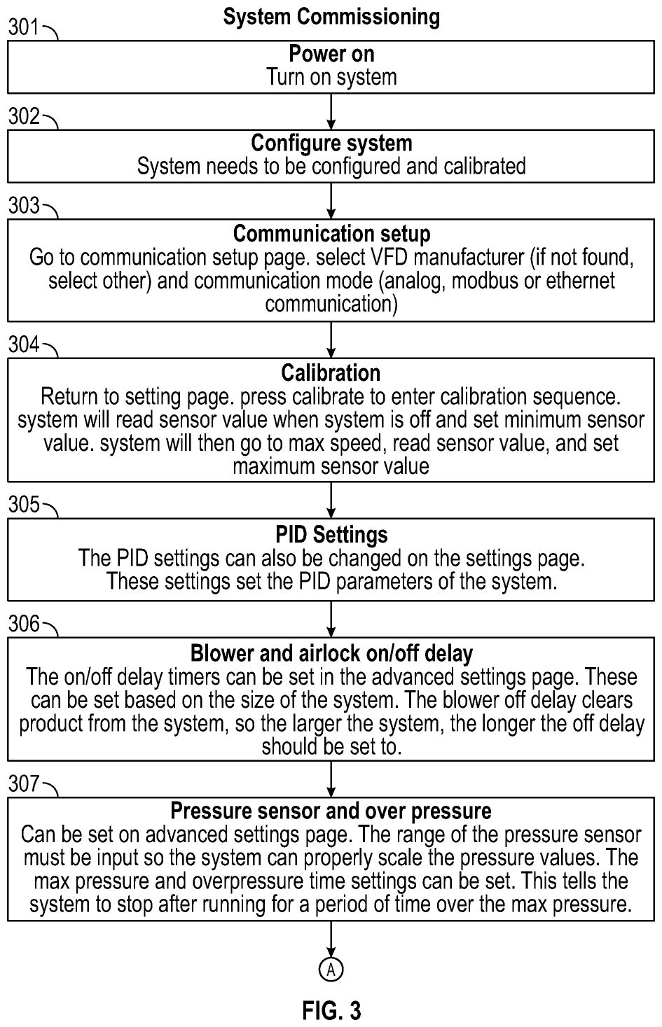

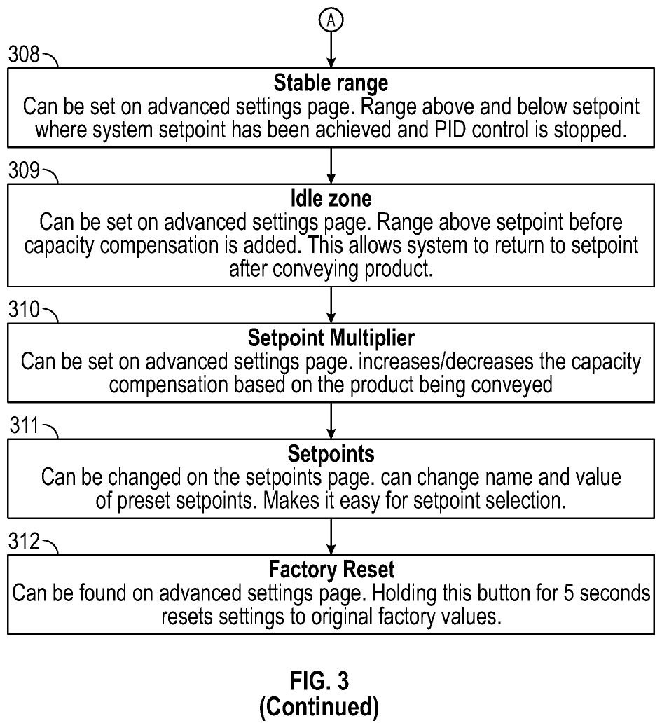

Reference is now made to FIGS. 3 to 6 describing exemplary system commissioning and system operation steps, as detailed below. It is to be understood herein that these are examples only and are subject to modifications, and such modifications are within the scope of this invention.

FIG. 3 illustrates an exemplary process of system commissioning, whereas:

At 301, the user turns the system ON.

At 302, the user starts configuring and calibrating the system.

At 303, the user can go to communication setup page to setup the communication, select VFD manufacturer (if not found select other) and communication mode between analog, modbus, or ethernet communication.

At 304, the user enters into a calibration sequence at setting page. The system reads sensor value when system is OFF and set minimum sensor value. The system then goes to max speed, reads sensor value, and set maximum sensor value.

At 305, the PID settings can also be changed on the setting page. If autotune is selected, the system automatically changes speeds and read the reaction time of the sensor, uses this to set the PID parameters of the system.

At 306, the on/off delay timers of the blower and the airlock can be set in the advanced setting page. These can be set based on the size of the system. The blower off delay clears product from the system, so the larger the system the longer the off delay should be set to.

At 307, the pressure sensor and over pressure can be set on advanced settings page. The range of the pressure sensor must be input so the system can properly scale the pressure values. The maximum pressure and over pressure time settings can be set. This instructs the system to stop after running for a period of time over the maximum pressure.

At 308, a stable range can be set on advanced setting page. Range above and below target where system set point has been achieved and PID control is stopped.

At 309, an idle zone can be set on advanced setting page. Range above target before capacity compensation is added. This instructs the system to return to target after conveying the product.

At 310, a target multiplier can be set on advanced settings page. The system increases/decreases the capacity compensation based on the product being conveyed.

At 311, the targets can be changed on the set points page. The user can also change name and value of the preset targets.

At 312, optionally the user can chose to restore to factory settings.

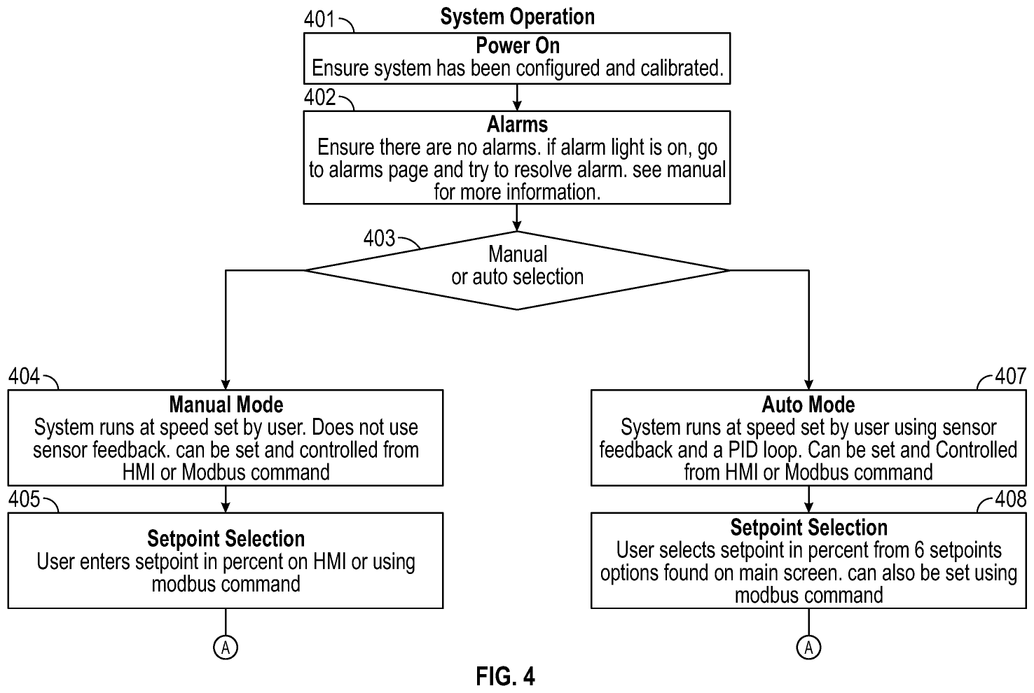

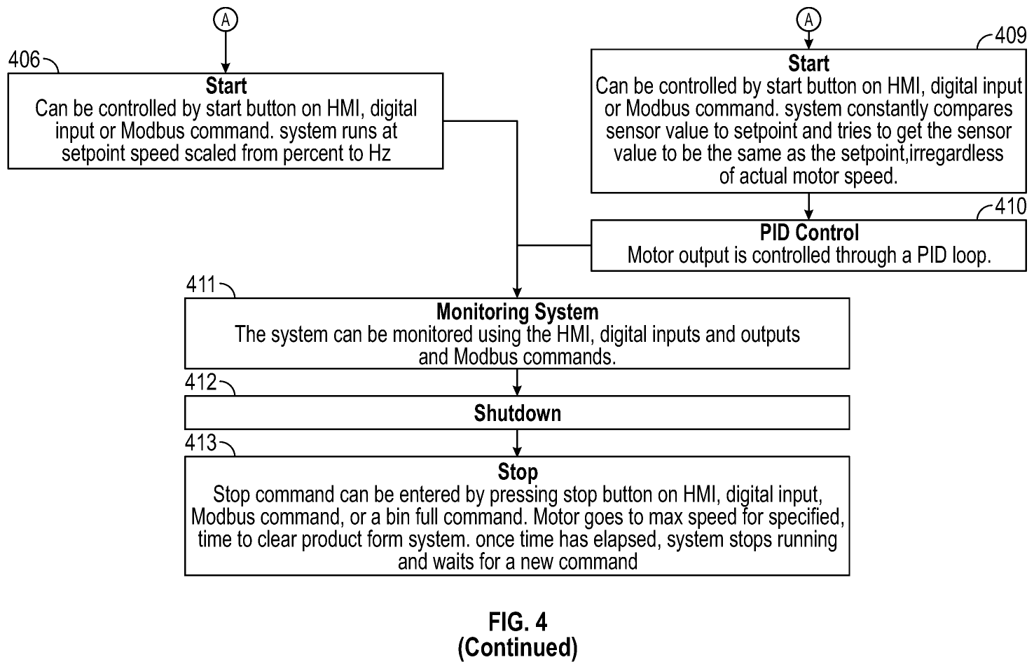

FIG. 4 illustrates an exemplary process of system operation, whereas:

At 401, once powered ON, the system ensures that the system has been configured and calibrated (for example as described above).

At 402, the user checks the alarms to ensure there are no alarms. If alarm light is ON, the user can go to alarms page and try to resolve the alarm.

At 403, the user choses between a manual mode and an auto mode.

If the user selects the manual mode, at 404, the system runs at speed set by the user, and does not use the sensor feedback. The speed and/or the mode can be set and controlled from HMI or modbus command. Additional modes include: (i) Unplug mode: The user can initiate unplug mode if the conveying line 120 is unplugged. Once this mode is activated, the blower motor 134 speed starts at a minimum speed and increases slowly, creating a path for grains to unplug conveying lines; and (ii) Drier Vac mode: The blower unit 130 and an airlock unit 150 start simultaneously, and the speed of the blower motor 134 remains constant throughout.

At 405, the user enters target in percent on HMI or using modbus command.

At 406, the operation starts, and can be controlled by start button on HMI, digital input, or modbus command. The system runs at target speed scales from percent to Hz.

If the user selects the auto mode, at 407, the system runs at speed set by user using sensor feedback and a PID loop. The speed and/or the mode can be set and controlled from HMI or modbus command.

At 408, the user selects target in percent from six set point options found on main screen or using modbus command.

At 409, the operation starts, and can be controlled by start button on HMI, digital input, or modbus command. The system constantly compares sensor value to set point and tries to get the sensor value to be the same as the set point, irregardless of actual motor speed.

At 410, the motor output is controlled through a PID loop.

Once the system is running, at 411, it can be monitored using the HMI, digital inputs/outputs and modbus commands.

At 412, in emergencies, pressing the emergency push button (or emergency lock) on the panel sends a signal to the PLC to stop everything immediately. The PLC corresponds to this signal stopping the blower unit 130 and an airlock unit 150. The user should release the emergency push button and press “Restart System” in HMI to restart the system.

At 413, the user can initiate a stop and shut down sequence, by pressing stop button on HMI, digital input, modbus command, or the system can initiate the stop and shut down sequence due to a bin full command (manually or automatically). The motor goes to maximum speed for a specified time to clear product from system. Once time has elapsed, system stops running and waits for a new command. The shut down sequence can be triggered when there is any blower/airlock fault or when the bin is full. In shut down mode, the blower unit 130 and airlock unit 150 are stopped.

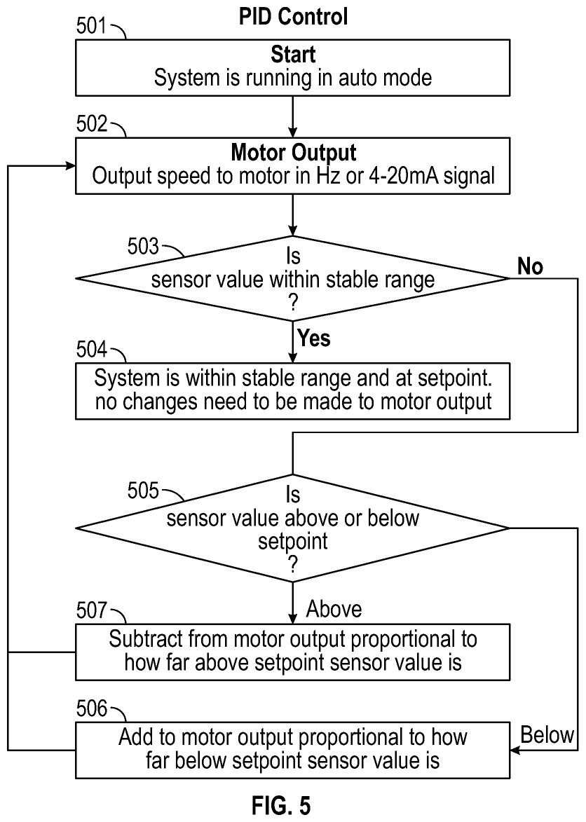

FIG. 5 illustrates an exemplary process of PID control, whereas:

At 501, the system starts running in auto mode.

At 502, the system outputs speed (in the form of a control signal) to motor in Hz or 4-20 mA signal.

At 503, the system determines whether a sensor value (air speed) is within stable range or not.

If it is determined that the sensor value is within stable range, the process moves to 504, where no changes are made to motor output and the system keeps on running.

If it is determined that the sensor value is not within stable range, the system at 505 checks whether the sensor value is above or below target. If it is determined that the sensor value is below the target, the process moves to 506, where the system adds to motor output proportional to how far below set point the sensor value is. If it is determined that the sensor value is above the target, the process moves to 507, where the system subtracts from motor output proportional to how far above target the sensor value is. The process proceeds to step 502 and the PID loop continues.

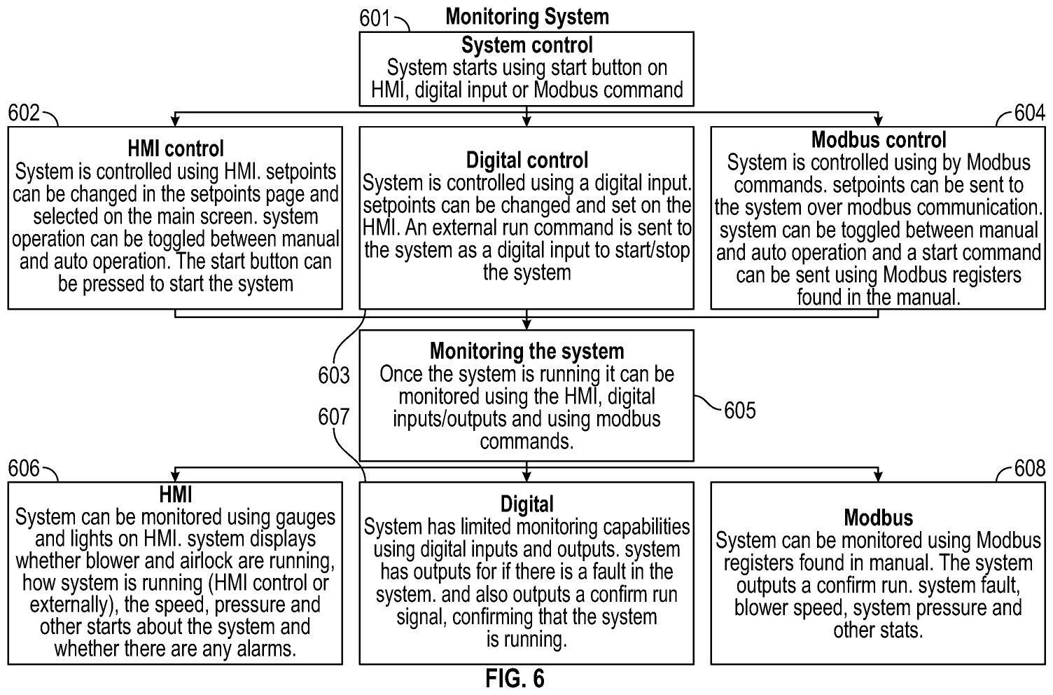

FIG. 6 illustrates an exemplary process of monitoring the system, whereas:

At 601, the system is started using start button on HMI, digital input, or modbus command.

In case of HMI control, at 602, the system is controlled using HMI targets, which can be changed in the targets page and selected on the main screen. The system operation can be toggled between manual and auto operation. The start button can be pressed to start the system.

In case of digital control, at 603, the system is controlled using a digital input. The targets can be changed and set on the HMI. An external run command is sent to the system as a digital input to start/stop the system.

In case of modbus control, at 604, the system is controlled using modbus commands. The targets can be sent to the system over modbus communication. The system operation can be toggled between manual and auto operation and a start command can be sent using modbus registers found in the manual.

Once the system is running, at 605, it can be monitored using the HMI, digital input/output and using modbus commands.

In case of HMI, at 606, the system can be monitored using gauges and lights on HMI. The system can display whether blower and airlock are running, how system is running (HMI control or externally), the speed, pressure, and other stats about the system and whether there are any alarms.

In case of digital input/output, at 607, the system has limited monitoring capabilities using digital inputs and outputs. The system has outputs for if there is a fault in the system, and outputs a confirm run signal, confirming that the system is running.

In case of modbus commands, at 608, the system can be monitored using modbus registers found in manual. The system outputs a confirm run, system fault, blower speed, system pressure, and other stats about the system.

What is claimed is:

1. A pneumatic conveyance system for conveying a product between a first unit and a second unit, said system comprising:
a conveying line configured for the product to be conveyed therethrough, the conveying line comprising a line inlet configured for coupling to the first unit for receiving the product from the first unit and a line outlet configured for coupling to the second unit for delivering the product to the second unit;
a blower unit configured for blowing a flow of air through the conveying line for conveying the product;
a sensor unit configured for measuring speed of air entering into the blower unit, and generating a sensor signal indicative thereof; and
a controller configured to receive the sensor signal and to generate a control signal for controlling the blower unit based at least upon the measured speed.

2. The pneumatic conveyance system according to claim 1, wherein the sensor unit comprises:
a fixed member deployed to interact with the air entering into the blower unit and experience a force exerted thereupon by the air; and
a force sensor operatively coupled to the fixed member and configured for measuring the force experienced by the fixed member and generating a voltage signal indicative of the force measurement, said voltage signal being configured to be converted into the measurement of the speed of the air entering into the blower unit.

3. The pneumatic conveyance system according to claim 2, wherein the controller is configured to convert the voltage signal into analog value and then to a programmable logic controller (PLC) constituting the control signal.

4. The pneumatic conveyance system according to claim 2, wherein the fixed member is configured to be stationary with respect to the air.

5. The pneumatic conveyance system according to claim 2, wherein the fixed member is a plate.

6. The pneumatic conveyance system according to claim 2, wherein the force sensor comprises a load cell.

7. The pneumatic conveyance system according to claim 2, wherein the sensor unit is configured to be positioned upstream of the blower unit.

8. The pneumatic conveyance system according to claim 1, wherein the sensor unit comprises a velocity sensor configured for determining the speed of the air entering into the blower unit.

9. The pneumatic conveyance system according to claim 1, wherein the blower unit comprises:
a blower configured for blowing said flow of air; and
a blower motor operatively connected to the blower and configured for driving the blower for blowing said flow of air.

10. The pneumatic conveyance system according to claim 9, wherein the blower motor has a variable frequency drive (VFD).

11. The pneumatic conveyance system according to claim 10, wherein the controller is configured to control the VFD via the control signal.

12. The pneumatic conveyance system according to claim 11, wherein the VFD is configured to adjust a speed of the blower.

13. The pneumatic conveyance system according to claim 9, wherein the blower comprises a positive displacement blower.

14. The pneumatic conveyance system according to claim 1, wherein the controller is configured to receive a predetermined target value range, and to maintain a speed of the flow of air within the predetermined target value range.

15. The pneumatic conveyance system according to claim 14, wherein the predetermined target value range comprises a single target value, and the controller is configured to maintain the speed of the flow of air at the target value.

16. The pneumatic conveyance system according to claim 14, wherein the controller is configured to measure a quantity of the product being conveyed, and to adjust the predetermined target value range based at least thereupon.

17. The pneumatic conveyance system according to claim 1, further comprising a communication interface configured for facilitating a user to enter commands to control the system.

19. A method for conveying a product between a first unit and a second unit, said method, performed by a pneumatic conveyance system, comprising:
conveying the product through a conveying line, the conveying line comprising a line inlet coupled to the first unit for receiving the product from the first unit and a line outlet coupled to the second unit for delivering the product to the second unit;
blowing, by a blower unit, a flow of air through the conveying line for conveying the product;
measuring speed of air entering into the blower unit;
generating a sensor signal indicative of the speed of air entering into the blower unit;
generating a control signal for controlling the blower unit based at least upon the measured speed; and
controlling the blower unit via the control signal.

20. The method according to claim 19, wherein said controlling the blower unit comprises controlling a variable frequency drive (VFD) of the blower unit.

21. The method according to claim 20, wherein said controlling the VFD comprises adjusting the speed of blower of the blower unit.

22. The method according to claim 19, further comprising receiving a predetermined target value range, and maintaining the speed of the flow of air within the predetermined target value range.

23. The method according to claim 22, wherein the predetermined target value range comprises a single target value, and the method comprises maintaining the speed of the flow of air at the target value.

24. The method according to claim 22, further comprising measuring a quantity of the product being conveyed, and adjusting the predetermined target value range based at least thereupon.

25. A sensor unit configured for measuring speed of a flow of air, said sensor unit comprising:
a fixed member configured to be deployed to interact with the flow of air and experience a force exerted thereupon by the flow of air; and
a force sensor operatively coupled to the fixed member and configured for measuring the force experienced by the fixed member and generating a voltage signal indicative of the force measurement, said voltage signal being convertible into the speed of the flow of air.
